(19) United States
(12) Patent Application Publication
(10) Pub. No.: US 2019/0378667 A1
(43) Pub. Date: Dec. 12, 2019

(54) KEYBOARD DEVICE

(71) Applicant: Primax Electronics Ltd., Taipei (TW)

(72) Inventors: YU-TING LING, Taipei (TW); PAI-PING HSU, Taipei (TW); HSIANG-WEN CHENG, Taipei (TW)

(21) Appl. No.: 16/111,105

(22) Filed: Aug. 23, 2018

(30) Foreign Application Priority Data
Jun. 8, 2018 (TW) 107119888

(51) Int. Cl. H01H 13/7065

(52) U.S. Cl. CPC H01H 13/7065; H01H 13/85

(57) ABSTRACT

A keyboard device includes a keycap, a connecting element and a base plate. The keycap includes a sliding-type hook. The connecting element includes a first frame and a second frame. A first connecting part is inserted into the sliding-type hook. The first connecting part includes a top side and a contact slant. The top side is located at a distal end of the first connecting part. The contact slant is arranged beside the top side. A junction line between the top side and the contact slant is perpendicular to a top surface of the first frame. Due to the structure of the contact slant, the contact area between the first connecting part and the sliding-type hook is reduced. Consequently, the amount of the assembling interference between the first connecting part and the sliding-type hook is reduced.

### FIELD OF THE INVENTION

The present invention relates to an input device, and more particularly to a keyboard device with plural key structures.

### BACKGROUND OF THE INVENTION

Generally, the widely-used peripheral input device of a computer system includes for example a mouse device, a keyboard device, a trackball device, or the like. Via the keyboard device, characters or symbols can be directly inputted into the computer system. As a consequence, most users and most manufacturers of input devices pay attention to the development of keyboards. The subject of the present invention is related to a keyboard device.

The partial structure of a keyboard device with a scissors-type connecting element will be described as follows. FIG. 1 is a schematic cross-sectional side view illustrating a portion of a conventional keyboard device. As shown in FIG. 1, the conventional keyboard device 1 comprises plural keycaps 11, plural scissors-type connecting elements 12, plural rubbery elastomers 13, a membrane switch circuit member 14 and a base plate 15. For succinctness, only one keycap 11, one scissors-type connecting element 12 and one rubbery elastomer 13 are shown in the drawing. The keycap 11, the scissors-type connecting element 12, the rubbery elastomer 13 and the membrane switch circuit member 14 are supported by the base plate 15. The scissors-type connecting element 12 is used for connecting the base plate 15 and the keycap 11. The keycap 11 comprises a sliding-type hook 111 and a fixing-type hook 112. The base plate 15 comprises a first base hook 151 and a second base hook 152.

The membrane switch circuit member 14 comprises plural key intersections (not shown). When one of the plural key intersections is triggered, a corresponding key signal is generated. The rubbery elastomer 13 is disposed on the membrane switch circuit member 14. Each rubbery elastomer 13 is aligned with a corresponding key intersection. When the rubbery elastomer 13 is depressed, the rubbery elastomer 13 is subjected to deformation to push the corresponding key intersection of the membrane switch circuit member 14. Consequently, the corresponding key signal is generated.

The scissors-type connecting element 12 is arranged between the base plate 15 and the keycap 11, and the base plate 15 and the keycap 11 are connected with each other through the scissors-type connecting element 12. The scissors-type connecting element 12 comprises a first frame 121 and a second frame 122. A first end of the first frame 121 is connected with the keycap 11. A second end of the first frame 121 is connected with the base plate 15. The first frame 121 comprises a first connecting part 1211 and a second connecting part 1212. The first frame 121 is connected with the sliding-type hook 111 of the keycap 11 through the first connecting part 1211. The first frame 121 is connected with the second base hook 152 of the base plate 15 through the second connecting part 1212. The second frame 122 is coupled with the first frame 121. Moreover, the second frame 122 can be swung relative to the first frame 121. A first end of the second frame 122 is connected with the first base hook 151 of the base plate 15. A second end of the second frame 122 is connected with the keycap 11. The second frame 122 comprises a third connecting part 1221 and a fourth connecting part 1222. The second frame 122 is connected with the fixing-type hook 112 of the keycap 11 through the third connecting part 1221. The second frame 122 is connected with the first base hook 151 of the base plate 15 through the fourth connecting part 1222.

The operations of the conventional key structure 1 in response to the depressing action of the user will be illustrated as follows. Please refer to FIG. 1 again. While the keycap 11 is depressed, the keycap 11 is moved downwardly to push the scissors-type connecting element 12 in response to the depressing force. Consequently, the scissors-type connecting element 12 is correspondingly moved. As the keycap 11 is moved downwardly relative to the base plate 15, the keycap 11 pushes the corresponding rubbery elastomer 13. At the same time, the rubbery elastomer 13 is subjected to deformation to push the membrane switch circuit member 14 and trigger the corresponding key intersection of the membrane switch circuit member 14. Consequently, the membrane switch circuit member 14 generates a corresponding key signal. When the keycap 11 is no longer depressed by the user, no external force is applied to the keycap 11 and the rubbery elastomer 13 is no longer pushed by the keycap 11. In response to the elasticity of the rubbery elastomer 13, the rubbery elastomer 13 is restored to its original shape to provide an upward elastic restoring force. Consequently, the keycap 11 is returned to its original position where it is not depressed.

When the scissors-type connecting element 12 is in a stacked state, the first frame 121 and the second frame 122 are in parallel with each other. Generally, the keycap 11 and the scissors-type connecting element 12 are combined together through a vertical assembling process. In accordance with the vertical assembling process, the scissors-type connecting element 12 in the stacked state is moved in a vertical direction. Consequently, the first connecting part 1211 is inserted into the sliding-type hook 111, and the third connecting part 1221 is inserted into the fixing-type hook 112. Since the sliding-type hook 111 is an open-type hook and the sliding-type hook 111 is open to a lateral side of the keycap 11, some drawbacks occur. For example, while the keycap 11 and the scissors-type connecting element 12 are combined together through the vertical assembling process, the first connecting part 1211 is obstructed by the sliding-type hook 111. Consequently, it is difficult to assemble the first connecting part 1211 with the sliding-type hook 111. Meanwhile, it is necessary to push the first connecting part 1211 and the sliding-type hook 111 in order to combine the first connecting part 1211 and the sliding-type hook 111 together. During the process of pushing first connecting part 1211 and the sliding-type hook 111, the first connecting part 1211 and the sliding-type hook 111 are abraded by each other and thus subjected to damage. If the damage is serious, the tactile feel of depressing the keycap 11 is impaired.

For smoothly assembling the keycap with the scissors-type connecting element, the first connecting part has a slant facing the keycap (i.e., facing upwardly). Consequently, the amount of the interference between the sliding-type hook and the first connecting part is reduced. Although the arrangement of the slant facilitates assembling the keycap with the scissors-type connecting element, the improvement efficacy is limited. After the sliding-type hook and the first connecting part are assembled with each other, the sliding-type hook and the first connecting part are still suffered from abrasion and damage. If the damage is serious, the tactile feel of depressing the keycap 11 is still impaired.

Therefore, there is a need of providing a keyboard device that is easily assembled and has enhanced tactile feel of depressing the keycap.

### SUMMARY OF THE INVENTION

An object of the present invention provides a keyboard device that is easily assembled and has enhanced tactile feel of depressing the keycap.

In accordance with an aspect of the present invention, there is provided a keyboard device. The keyboard device includes a keycap, a connecting element and a base plate. The keycap is exposed outside the keyboard device, and includes a sliding-type hook. The connecting element is connected with the keycap. Moreover, the connecting element includes a first frame and a second frame. The first frame includes a first connecting part. The first connecting part is inserted into the sliding-type hook. The first connecting part has a top side and a contact slant. The top side is located at a distal end of the first connecting part. The contact slant is arranged beside the top side. The second frame is connected with the first frame. The second frame is permitted to be swung relative to the first frame. The base plate is located under the keycap and connected with the connecting element. The connecting element and the keycap are supported by the base plate, and a junction line between the top side and the contact slant is perpendicular to a top surface of the first frame.

In an embodiment, the first connecting part is externally protruded from a lateral wall of the first frame. The first connecting part is perpendicular to the lateral wall of the first frame. The top side of the first connecting part is in parallel with the lateral wall of the first frame.

In an embodiment, the sliding-type hook has a guiding slant, and the guiding slant is disposed on an outer surface of the sliding-type hook. When the sliding-type hook is contacted with the first connecting part, the first connecting part is pushed by the sliding-type hook and the contact slant is moved along the guiding slant of the sliding-type hook so as to facilitate inserting the first connecting part into the sliding-type hook.

From the above description, the present invention provides the keyboard device. The connecting element is specially designed. The first connecting part of the first frame has the contact slant beside the top side. The junction line between the top side and the contact slant is perpendicular to the top surface of the first frame. That is, the contact slant of the first connecting part faces the lateral wall of the first frame. Moreover, the sliding-type hook of the keycap has a guiding slant corresponding to the contact slant. Due to the structures of the contact slant and the guiding slant, the contact area between the first connecting part and the sliding-type hook is reduced and the amount of the assembling interference between the first connecting part and the sliding-type hook is reduced. Since the possibility of resulting in the damage of the first connecting part in the assembling process is largely reduced, the tactile feel of depressing the keycap is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional side view illustrating a portion of a conventional keyboard device;

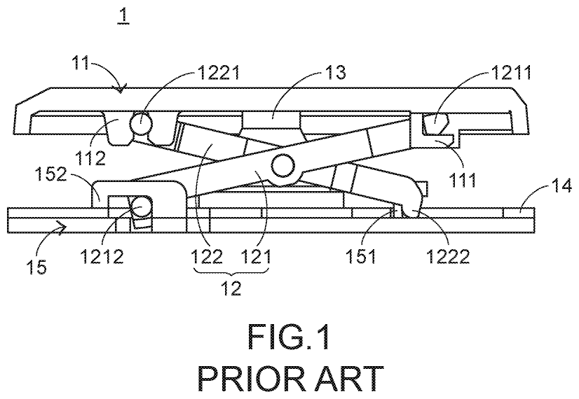

FIG. 2 is a schematic exploded view illustrating a portion of a keyboard device according to an embodiment of the present invention and taken along a viewpoint;

FIG. 3 is a schematic exploded view illustrating the keycap and the connecting element of the keyboard device according to the embodiment of the present invention and taken along another viewpoint;

FIG. 4 is a schematic perspective view illustrating the relationship between the keycap and the connecting element of the keyboard device during the assembling process;

FIG. 5 is a schematic bottom view illustrating the relationship between the keycap and the connecting element of the keyboard device during the assembling process;

FIG. 6 is a schematic perspective view illustrating the assembled structure of the keycap and the connecting element of the keyboard device; and

FIG. 7 is a schematic cross-sectional view illustrating a portion of the keyboard device according to the embodiment of the present invention.

### DETAILED DESCRIPTION OF THE PREFERRED EMBODIMENT

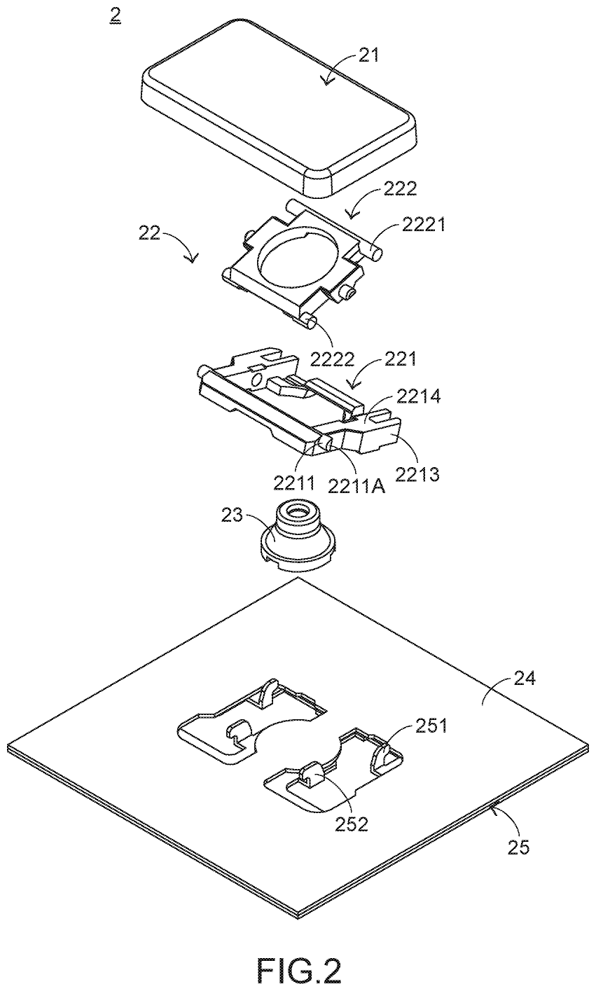

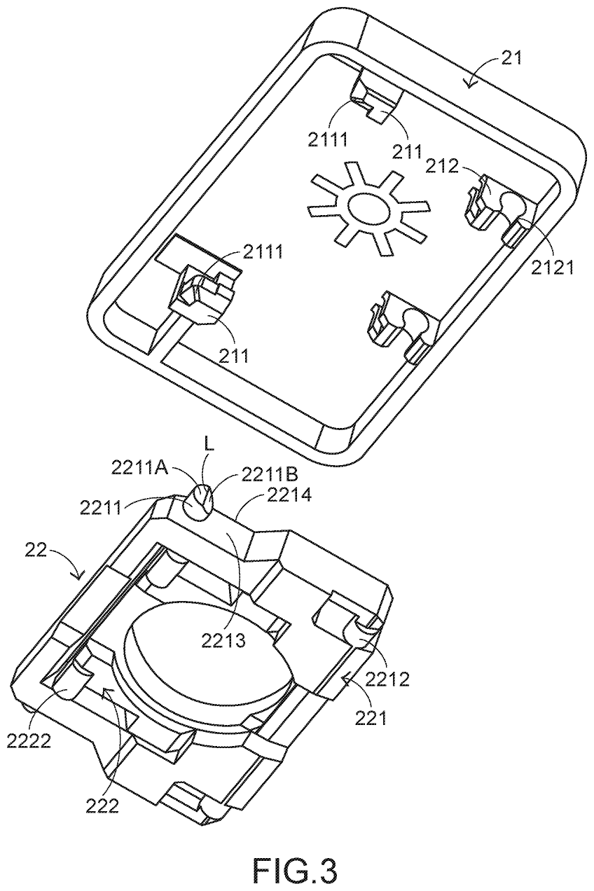

For solving the drawbacks of the conventional technologies, the present invention provides a keyboard device. Hereinafter, the structure of the keyboard device of the present invention will be described with reference to FIGS. 2 and 3. FIG. 2 is a schematic exploded view illustrating a portion of a keyboard device according to an embodiment of the present invention and taken along a viewpoint. FIG. 3 is a schematic exploded view illustrating the keycap and the connecting element of the keyboard device according to the embodiment of the present invention and taken along another viewpoint. The keyboard device 2 comprises plural keycaps 21, plural connecting elements 22, plural elastic elements 23, a switch circuit member 24 and a base plate 25. For succinctness, only one keycap 21, one connecting element 22 and one elastic element 23 are shown in the drawings. The keycap 21 is exposed outside the keyboard device 2. The keycap 21 comprises a sliding-type hook 211 and a fixing-type hook 212. The sliding-type hook 211 and the fixing-type hook 212 are disposed on an inner surface of the keycap 21. The sliding-type hook 211 is located at a first side of the keycap 21. The fixing-type hook 212 is located at a second side of the keycap 21. In an embodiment, the sliding-type hook 211 and the fixing-type hook 212 are made of a plastic material. Moreover, the sliding-type hook 211 and the fixing-type hook 212 are integrally formed with the keycap 21.

The connecting element 22 is connected with the keycap 21. The connecting element 22 comprises a first frame 221 and a second frame 222. The second frame 222 is connected with the first frame 221. Moreover, the second frame 222 can be swung relative to the first frame 221. The base plate 25 is located under the keycap 21 and connected with the connecting element 22. The plural keycaps 21 and the plural connecting elements 22 are supported by the base plate 25. The base plate 25 comprises plural first base hooks 251 and plural second base hooks 252. The plural first base hooks 251 are located at a first side of the base plate 25. The plural second base hooks 252 are located at a second side of the base plate 25.

The switch circuit board 24 is located under the plural keycaps 21. When the switch circuit board 24 is triggered by one of the plural elastic elements 23, the corresponding key signal is generated. The elastic element 23 is arranged between the corresponding keycap 21 and the switch circuit board 24. As the keycap 21 is moved downwardly to push the elastic element 23, the switch circuit board 24 is triggered by the elastic element 23. In an embodiment, the switch circuit board 24 is a membrane switch circuit board, the elastic element 23 is a rubbery elastomer, and the base plate 25 is made of a metallic material.

The detailed structure of the connecting element 22 will be described as follows. Please refer to FIGS. 2 and 3 again. The first frame 221 comprises a first connecting part 2211 and a second connecting part 2212. The first connecting part 2211 is inserted into the sliding-type hook 211. The second connecting part 2212 is inserted into the first base hook 251. The first connecting part 2211 is externally protruded from a lateral wall 2213 of the first frame 221. Moreover, the first connecting part 2211 is perpendicular to the lateral wall 2213 of the first frame 221. The second frame 222 comprises a third connecting part 2221 and a fourth connecting part 2222. The third connecting part 2221 is inserted into the fixing-type hook 212. The fourth connecting part 2222 is inserted into the second base hook 252.

For solving the drawbacks of the conventional technologies, the first frame 221 is specially designed. The first connecting part 2211 has a top side 2211A and a contact slant 2211B. The top side 2211A is located at a distal end of the first connecting part 2211. The contact slant 2211B is arranged beside the top side 2211A. The top side 2211A is in parallel with the lateral wall 2213 of the first frame 221. A junction line L between the top side 2211A and the contact slant 2211B is perpendicular to a top surface 2214 of the first frame 221. That is, the contact slant 2211B faces the lateral wall 2213 of the first frame 221. Moreover, the sliding-type hook 211 has a guiding slant 2111 corresponding to the contact slant 2211B. The guiding slant 2111 is disposed on an external surface of the sliding-type hook 211.

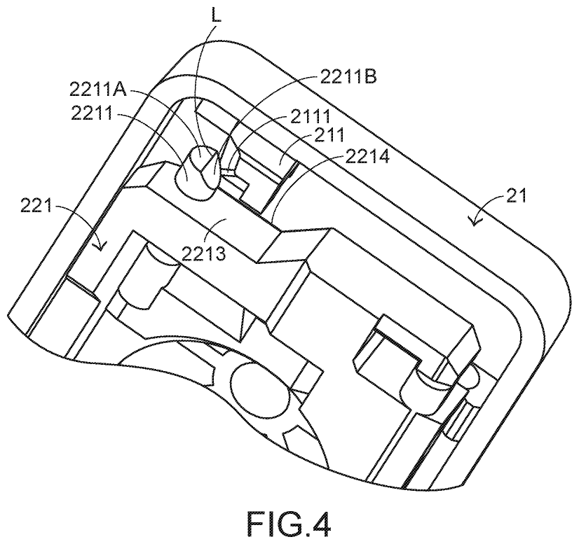

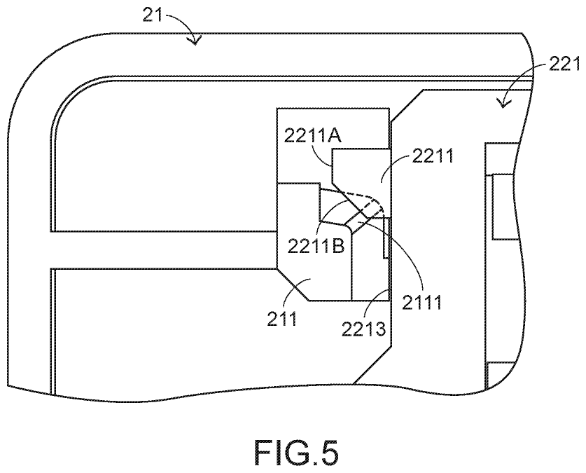

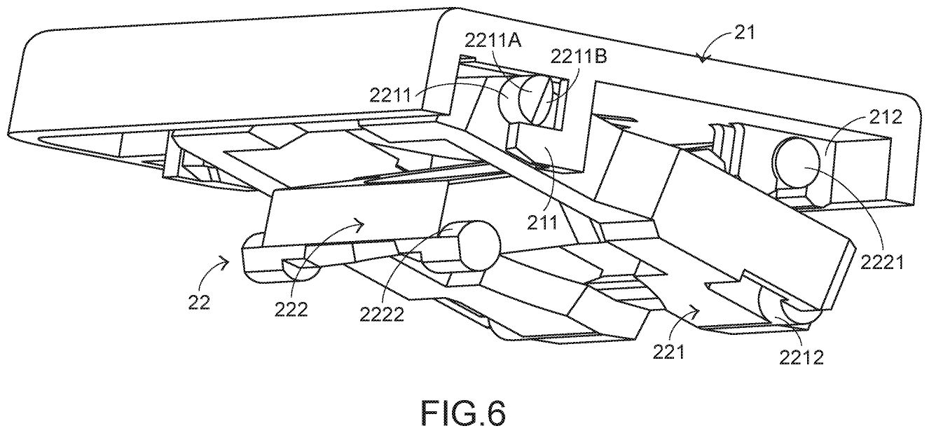

A process of assembling the keycap 21 with the connecting element 22 will be described as follows. Please refer to FIGS. 4, 5 and 6. FIG. 4 is a schematic perspective view illustrating the relationship between the keycap and the connecting element of the keyboard device during the assembling process. FIG. 5 is a schematic bottom view illustrating the relationship between the keycap and the connecting element of the keyboard device during the assembling process. FIG. 6 is a schematic perspective view illustrating the assembled structure of the keycap and the connecting element of the keyboard device. The keycap 21 and the connecting element 22 of the keyboard device 2 are combined together through a vertical assembling process. Firstly, the connecting element 22 is in a stacked state (i.e., the first frame 221 and the second frame 222 are in parallel with each other), and the connecting element 22 and the keycap 21 are in parallel with each other. Then, the connecting element 22 is moved in the vertical direction while the connecting element 22 and the keycap 21 are maintained in the parallel state. As shown in FIG. 4, the connecting element 22 is close to the keycap 21. That is, the first connecting part 2211 of the first frame 221 is close to the sliding-type hook 211 of the keycap 21.

When the first connecting part 2211 is contacted with the sliding-type hook 211, the first connecting part 2211 is pushed by the sliding-type hook 211. In response to the elasticity of the plastic material, the first connecting part 2211 is subjected to slight deformation. Moreover, the contact slant 2211B of the first connecting part 2211 is moved along the guiding slant 2111 of the sliding-type hook 211. Consequently, the first connecting part 2211 is inserted into the sliding-type hook 211 more easily. Moreover, when the first connecting part 2211 is contacted with the sliding-type hook 211, the fixing-type hook 212 is contacted with the third connecting part 2221. In addition, the third connecting part 2221 is moved along an inner side 2121 of the fixing-type hook 212 and coupled with the fixing-type hook 212 (see FIG. 6).

As mentioned above, the first connecting part 2211 has the contact slant 2211B. In comparison with the first connecting part without the contact slant, the contact area between the first connecting part 2211 and the sliding-type hook 211 of the keyboard device 2 is reduced. The dotted region as shown in FIG. 5 indicates the contact area between the first connecting part 2211 and the sliding-type hook 211. Since the amount of the assembling interference between the first connecting part 2211 and the sliding-type hook 211 is reduced, the possibility of resulting in the damage of the first connecting part 2211 is largely reduced.

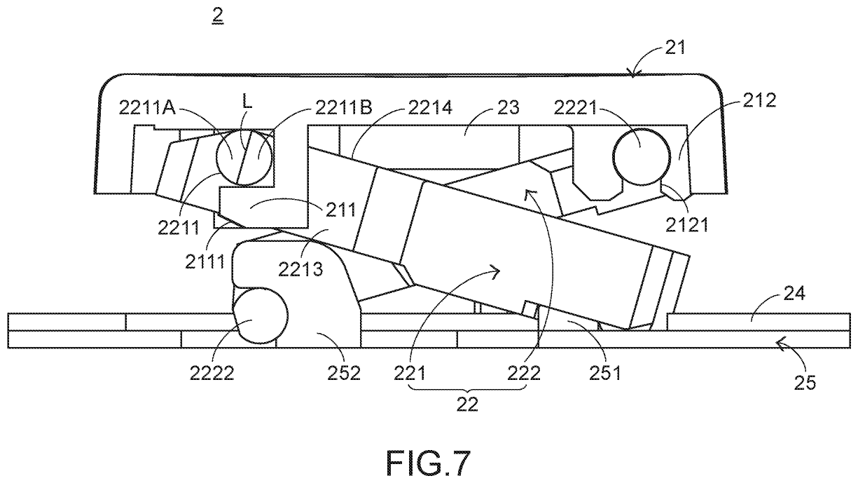

The operations of the components of the keyboard device 2 in response to a depressing action of the keycap 21 will be described as follows. FIG. 7 is a schematic cross-sectional view illustrating a portion of the keyboard device according to the embodiment of the present invention. While the keycap 21 is depressed, the keycap 21 is moved downwardly relative to the base plate 25. Consequently, the first frame 221 and the second frame 222 of the connecting element 22 are switched from an open-scissors state to the stacked state. At the same time, the third connecting part 2221 of the second frame 222 is rotated within the fixing-type hook 212, and the first connecting part 2211 of the first frame 221 is rotated and slid within the sliding-type hook 211. Consequently, the keycap 21 is moved downwardly to push the elastic element 23.

As the keycap 21 is moved downwardly to the elastic element 23, the elastic element 23 is subjected to deformation and the switch circuit member 24 is triggered by the elastic element 23. Consequently, the switch circuit member 24 generates a key signal corresponding to the keycap 21. When the keycap 21 is no longer depressed, the keycap 21 is moved upwardly relative to the base plate 25 in response to an elastic force of the elastic element 23. Meanwhile, the first frame 221 and the second frame 222 are switched from the stacked state to the open-scissors state, and the keycap 21 is returned to its original position.

From the above description, the present invention provides the keyboard device. The connecting element is specially designed. The first connecting part of the first frame has the contact slant beside the top side. The junction line between the top side and the contact slant is perpendicular to the top surface of the first frame. That is, the contact slant of the first connecting part faces the lateral wall of the first frame. Moreover, the sliding-type hook of the keycap has a guiding slant corresponding to the contact slant. Due to the structures of the contact slant and the guiding slant, the contact area between the first connecting part and the sliding-type hook is reduced and the amount of the assembling interference between the first connecting part and the sliding-type hook is reduced. Since the possibility of resulting in the damage of the first connecting part in the assembling process is largely reduced, the tactile feel of depressing the keycap is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a keycap exposed outside the keyboard device, and comprising a sliding-type hook;
a connecting element connected with the keycap, and comprising:
a first frame comprising a first connecting part, wherein the first connecting part is inserted into the sliding-type hook, and the first connecting part has a top side and a contact slant, wherein the top side is located at a distal end of the first connecting part, and the contact slant is arranged beside the top side; and
a second frame connected with the first frame, wherein the second frame is permitted to be swung relative to the first frame; and
a base plate located under the keycap and connected with the connecting element, wherein the connecting element and the keycap are supported by the base plate, and a junction line between the top side and the contact slant is perpendicular to a top surface of the first frame.

2. The keyboard device according to claim 1, wherein the first connecting part is externally protruded from a lateral wall of the first frame, wherein the first connecting part is perpendicular to the lateral wall of the first frame, and the top side of the first connecting part is in parallel with the lateral wall of the first frame.

3. The keyboard device according to claim 1, wherein the sliding-type hook has a guiding slant, and the guiding slant is disposed on an outer surface of the sliding-type hook, wherein when the sliding-type hook is contacted with the first connecting part, the first connecting part is pushed by the sliding-type hook, and the contact slant is moved along the guiding slant of the sliding-type hook, so that the first connecting part is inserted into the sliding-type hook easily.

4. The keyboard device according to claim 1, wherein the keycap further comprises a fixing-type hook, wherein the fixing-type hook is located at a first side of the keycap and connected with a third connecting part of the second frame, and the sliding-type hook is located at a second side of the keycap.

5. The keyboard device according to claim 4, wherein when the sliding-type hook is connected with the first connecting part, the fixing-type hook is connected with the third connecting part, and the third connecting part is moved along an inner side of the fixing-type hook and connected with the fixing-type hook.

6. The keyboard device according to claim 1, further comprising:
a switch circuit board located under the key structure; and
an elastic element arranged between the keycap and the switch circuit board, wherein when the elastic element is pushed by the keycap, the switch circuit board is triggered by the elastic element so as to generate a key signal, wherein when the elastic element is not pushed by the keycap, the keycap is returned to an original position in response to an elastic force of the elastic element.

7. The keyboard device according to claim 6, wherein while the keycap is depressed, the second frame is pushed by the keycap and rotated relative to the first frame, a third connecting part of the second frame is rotated within a fixing-type hook of the keycap, and the first connecting part is rotated and slid within the sliding-type hook, so that the elastic element is pushed by the keycap.

8. The keyboard device according to claim 1, wherein the base plate comprises:
a first base hook located at a first side of the base plate, and connected with a second connecting part of the first frame; and
a second base hook located at a second side of the base plate, and connected with a fourth connecting part of the second frame,
wherein while the keycap is depressed, the second connecting part is rotated within the first base hook, and the fourth connecting part is rotated and slid within the second base hook.
